(19) United States
(12) Patent Application Publication
(10) Pub. No.: US 2010/0023950 A1
(43) Pub. Date: Jan. 28, 2010

(54) WORKFLOW PROCESSING APPARATUS

(75) Inventor: Kenichi Fujii, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/497,991

(22) Filed: Jul. 6, 2009

(30) Foreign Application Priority Data
Jul. 24, 2008 (JP) 2008-191378

(51) Int. Cl. G06F 9/46

(52) U.S. Cl. 718/105

(57) ABSTRACT

A workflow processing apparatus receives interface information of a function provided by a device on a network from the device on the network and sends, during the processing of a workflow, input information based on the interface information of the function provided by the device on the network and a program for controlling the function provided by the device on the network to the device on the network.

### BACKGROUND OF THE INVENTION

1. Field of the Invention

The present invention relates to a workflow processing apparatus.

2. Description of the Related Art

In recent years, office appliances and even household appliances are being provided with software that enables the implementation of cooperative processing over a network. However, practically speaking, it is difficult for a single piece of software or a single system to meet the increasingly diverse needs of users to due to the complexity of those needs. Attempts are therefore being made to implement desired functions by dividing software used to configure devices, computers, and so on into multiple reusable units and reconstructing the software by switching those units as necessary. Composing a single large operational process by connecting multiple devices, computers, or the like over a network and operating those devices cooperatively is another idea that has appeared.

Systems in which the units, flow, and so on of the processes to be executed by a computer conform to a workflow, or a flow of manual tasks performed by humans, are called computer-based “workflow systems”. Meanwhile, software designed to configure a workflow system on a computer is generally called a “workflow management system”. The term “workflow” used here refers to an entity that reflects the actual tasks a human performs, and is composed by combining units of small tasks called “activities”. The functions of devices, software, and so on that compose the workflow system are used in appropriate combinations when executing activities through a computer system.

Here, a “web service”, which is a representative technique for constructing a workflow management system, and BPEL4WS shall be given as an example. A web service is a technique for implementing remote processing over a generic network by combining various XML specifications. WSDL, which is a specification for describing a standardized interface in web service technology, and SOAP, which is a specification for messages used to access an interface defined by the stated WSDL, are two representative specifications defined by the W3C. “W3C” is an acronym for “World Wide Web Consortium”, and “WSDL” is an acronym for “Web Service Description Language”. “SOAP”, meanwhile, is an acronym for “Simple Object Access Protocol”.

“BPEL4WS” is an acronym for “Business Process Execution Language for Web Services”, and is used to define the behavior of a business process that links multiple web services. The BPEL4WS specification is managed by the Web Services Business Process Execution Language TC of the XML standardization organization OASIS. “OASIS”, meanwhile, is an acronym for “Organization for the Advancement of Structured Information Standards”. “TC” is an acronym for “Technical Committee”. BPEL4WS is a flow process description language for describing a process that links multiple planned services, and can combine WSDL portTypes to compose a virtual web service.

When the functions of existing devices, software, and so on are combined as defined activities and a workflow system is constructed, a more expandable system can be realized in a shorter amount of time than when new application programs necessary for the tasks are developed from scratch. The technique disclosed in, for example, Japanese Patent Laid-Open No. 2004-361993 can be given as a technique that aims, in such a manner, to construct a process in which the overall system processing performed by a comparatively large piece of software is broken up into small units. This involves combining unit workflows, which perform comparatively small processes, thereby dynamically composing and executing a single, overall logical workflow.

Furthermore, the technique disclosed in, for example, Japanese Patent Laid-Open No. 6-075892 can be given as a technique for handling an individual piece of software as a part of a separate overall process. This technique aims to make it possible to call remote procedures supplied by a system without defining those remote procedures of the system in the interface of the service.

However, conventional application programs are already installed in specific devices, computers, and so on, and thus it is necessary to enable them to be accessed over the network as parts of the workflow system. For example, with the invention disclosed in Japanese Patent Laid-Open No. 2004-361993, the entity that combines individual workflows and executes those as an overall workflow is essentially the workflow execution apparatus. In other words, the execution of the individual workflows and the execution of the overall workflow cannot be divided among an application program and a workflow execution program. For this reason, conventional application programs running on an apparatus that is separate from a workflow program execution apparatus cannot be integrated into the overall processing of the workflow system.

In addition, the software, devices, and so on handled within a workflow system are required to operate under a processing structure in which they are capable of acting as activities, which are the units in which the workflow system processing is handled. Further still, existing application programs not intended to be externally controlled by workflow systems lack, by nature, the functionality to receive various processing requests over a network and return the processing results over the network.

In order to allow such existing application programs to perform processes as activities, which are parts of the workflow system, it is necessary to carry out a process for, for example, modifying the application program so as to make it network-compatible.

The technique disclosed in Japanese Patent Laid-Open No. 6-075892 can be given as a technique that can be used to add a function for network compatibility to existing software. According to this technique, when, in a client server system, a server that provides a service (function) is called, the appropriate external function is automatically searched for and called as a proxy.

However, this technique simply transfers a request for a certain service's function through another virtual service and calls that service. Therefore, when applying this technique to a workflow system, it is necessary for the processing units of the functions to be performed by the application program in question to conform to the processing units, or activities, requested by the workflow system. For example, when the conventional BPEL4WS is used as a workflow description language in the workflow system, BPEL4WS is required to support the input/output of activities as XML web services. Thus, if the input/output of information through XML is not supported by an application program, that application program cannot be handled by the workflow system as an activity, even if the process can be transferred dynamically.

To put it differently, the interface for the functions provided by a corresponding application program cannot be changed under this system. As a result, existing applications that can be modified so as to be usable as activities are limited to applications that already have units of input/output information when acting as activities.

### SUMMARY OF THE INVENTION

The present invention provides a workflow processing apparatus capable of utilizing, through a workflow, a function provided by a device on a network, without changing the interface of the function provided by the device on the network.

According to one aspect of the present invention, there is provided a workflow processing apparatus connected to a network, the apparatus comprising: a receiving unit that receives interface information of a function provided by a device on the network from the device on the network; and a sending unit that, during the processing of a workflow, sends input information based on the interface information of the function provided by the device on the network and a program for controlling the function provided by the device on the network to the device on the network.

Further features of the present invention will become apparent from the following description of exemplary embodiments (with reference to the attached drawings).

### BRIEF DESCRIPTION OF THE DRAWINGS

FIG. 1 is a block diagram illustrating an example of the configuration of a computer device according to an embodiment of the present invention.

FIG. 2 is a diagram illustrating software configurations of a workflow processing device and activity processing devices in a workflow system.

FIG. 3 is a diagram illustrating detailed configurations of an activity processing device and a workflow processing device.

FIG. 4 is a flowchart illustrating processing executed by an activity processing device as preparation before a workflow program process is executed.

FIG. 5 is a flowchart illustrating processing executed by a workflow processing device as preparation before a workflow program process is executed.

FIG. 6 is a flowchart illustrating processing executed by a workflow processing device at the stage when a workflow program process is actually executed.

FIG. 7 is a flowchart illustrating processing executed by an activity processing device at the stage when a workflow program process is actually executed.

FIG. 8 is a diagram illustrating detailed configurations of an activity processing device and a workflow processing device.

FIG. 9 is a flowchart illustrating a part of processing performed in an embodiment of the present invention.

### DESCRIPTION OF THE EMBODIMENTS

Preferred embodiments for carrying out the present invention shall be described in detail hereinafter with reference to the drawings.

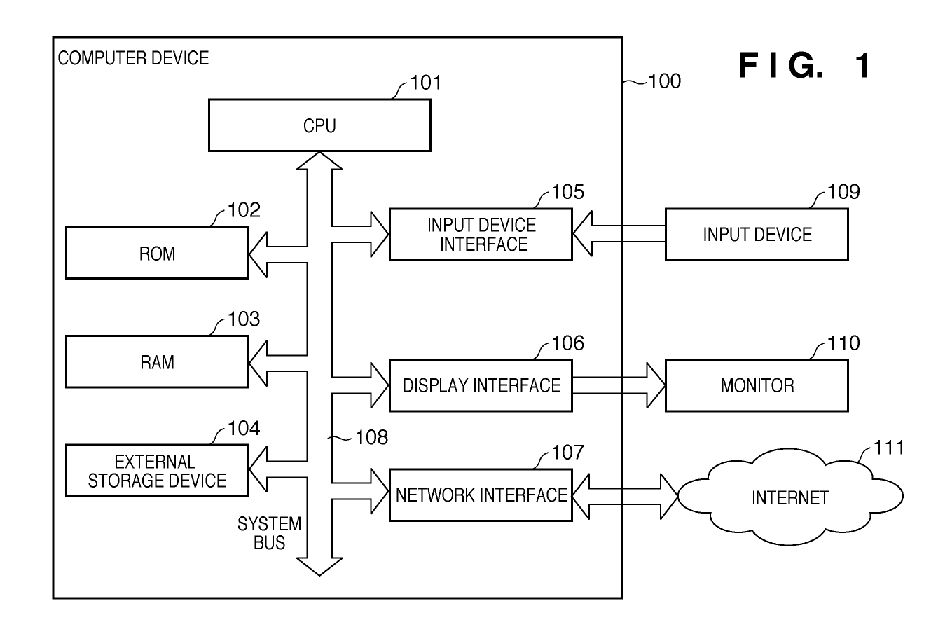

The configuration of a computer that functions as a workflow processing device and an activity processing device in a first embodiment of the present invention shall be described with reference to the block diagram in FIG. 1. FIG. 1 is a block diagram illustrating an example of the configuration of a computer device according to the present embodiment. In FIG. 1, reference numeral 101 is a CPU that controls a computer device 100 as a whole. Reference numeral 102 is a ROM that stores programs, parameters, and so on that do not require alterations. Reference numeral 103, meanwhile, is a RAM that temporarily stores programs, data, and so on supplied from an external device or the like.

Reference numeral 104 is an external storage device such as a hard disk or a memory card fixedly installed in the computer device 100, or that is removable from the computer device 100. Here, the external storage device may also be a flexible disk (FD), an optical disk such as a compact disc (CD), a magnetic or optically-read card, a smartcard, a memory card, or the like. 105 is an input device interface that accepts user operations, interfacing with an input device 109, such as a pointing device, a keyboard, or the like used to input data.

Reference numeral 106 is a display interface for a monitor 110 that displays data held in the computer device 100, supplied data, and so on. Reference numeral 107 is a network interface for connecting to a network line such as the Internet 111. Finally, reference numeral 108 is a system bus that connects the units 101 to 107 in a communicable state.

Before providing an outline of an activity processing device, activities that are already defined under BPEL4WS shall be described first. These activities include those described hereinafter.

(Invoke, Reply, Receive Activities)

This is an activity group by which a process interacts with the exterior; invoke calls a service provided by a partner. Reply and receive, meanwhile, are used to provide a service to a partner.

(Assign Activity)

This is an activity that copies data from one variable (XML message) to another variable (XML message), creates new data using the XPath language, and so on. It includes one or multiple <copy> elements. A <copy> element includes <from> and <to > elements, and <from> can be modified using XPath.

(Sequence, Switch, Pick, and while Activities)

This is an activity group that controls execution. Sequence sequentially executes internal activities. Switch switches conditions based on a conditional expression written in XPath. Pick defines event handlers and determines which of those to execute. Finally, while iteratively runs an activity while the XPath conditional expression is true.

(Scope, Flow Activities)

Scope defines the scope of exception processes and the like. It affects fault handler, compensation handler, correlation set, and so on. Flow executes processes in parallel. Flow graphs are composed of links/link.

A serial workflow process in which web services are employed at the activity level can be written using BPEL4WS by combining already-defined activities, as described above, with activities that call external web services.

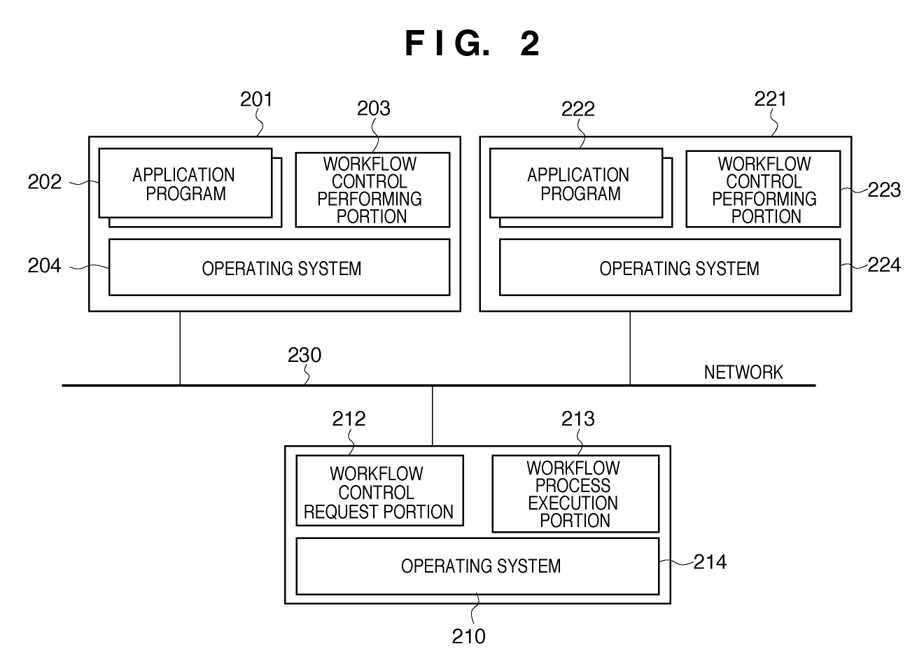

Next, an outline of the software configurations of the workflow processing device and the activity processing device, of which a workflow system is composed, shall be provided using FIG. 2. FIG. 2 is a diagram illustrating software configurations of the workflow processing device and the activity processing devices in the workflow system. Reference numerals 201 and 221 are activity processing devices that execute individual application programs corresponding to activities (services) in the overall workflow processing. Reference numeral 210, meanwhile, is a workflow processing device that performs the overall workflow processing. The devices 201, 210, and 221 are connected to one another via a network 230. Furthermore, the hardware of which the devices 201, 210, and 221 are configured is as shown in FIG. 1.

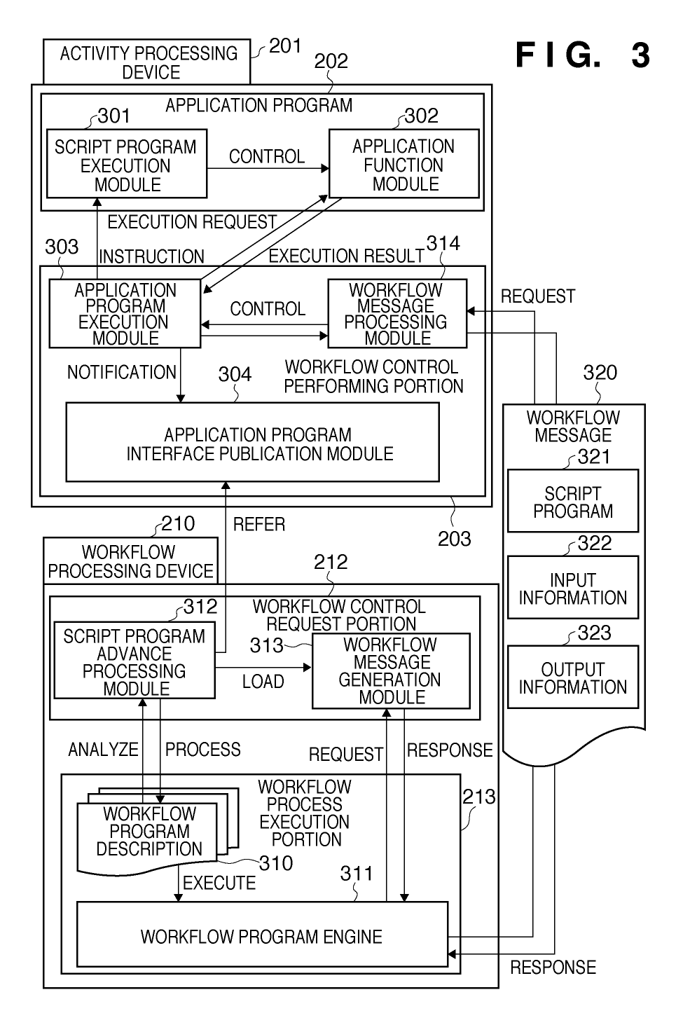

The activity processing device 201 includes, as its principle software, an application program 202, a workflow control performing portion 203, and an operating system 204 that functions as the base on which the aforementioned software runs. Here, the application program 202 is a program for an application, installed in the device, that can be executed individually. The workflow control performing portion 203 is software for enabling individual application programs 202 to be provided to the exterior as activities (services) in a workflow. The operating system 204 may be any known operating system (OS), and thus detailed descriptions thereof shall be omitted. Note that the application program 202 and the workflow control performing portion 203 shall be described in further detail later using FIG. 3.

In FIG. 2, the activity processing device 221 includes similar software as that included in the activity processing device 201. An application program 222 is a program for an application, installed in the device, that can be executed individually. A workflow control performing portion 223 is software for enabling individual application programs 222 to be provided to the exterior as activities (services) in a workflow. An operating system 224 may be any known operating system (OS), and thus detailed descriptions thereof shall be omitted. Thus, multiple activity processing devices may be present in a single workflow system, as is the case with the activity processing devices 201 and 221. In such a case, the devices can be applied to the present invention even if their configurations differ as long as the principle configurations are the same.

Meanwhile, the workflow processing device 210 includes, as its principle software, a workflow control request portion 212, a workflow process execution portion 213, and an operating system 214 that functions as the base on which the aforementioned software runs.

The workflow control request portion 212 generates workflow messages for causing the application program 202 or 222 to function as an activity (a service). The workflow process execution portion 213 makes a request to an activity processing device for the generated workflow message if, during the execution of the workflow process, an activity is a call for the activity processing device. The workflow process execution portion 213 then receives the processing result of the application program 202 or 222 from the activity processing device. The operating system 214 may be any known operating system (OS), and thus detailed descriptions thereof shall be omitted. Note that the workflow control request portion 212 and the workflow process execution portion 213 shall be described in further detail later using FIG. 3.

Although FIG. 2 is a diagram that has been simplified in order to show an outline of the device software, there are also cases where drivers enabling the devices to process peripheral devices, various utilities, network processing software, and so on are installed therein. It is assumed that these are all included within the operating system as software managed by that operating system, which is basically present in each of the devices.

Note also that the application program 202 or 222 in the activity processing device 201 or 221 is not limited to a single program; multiple programs may be present as well. This refers to a case where multiple application programs with different functions for a single device, different capabilities and specifications, and so on are installed in the activity processing device. For example, the application program 202 may be a combination of a document processing application program that provides a document processing function and an image processing application program that provides an image processing function. Hereinafter, multiple application programs shall be referred to collectively as an “application program”. Likewise, there may be, as shown in FIG. 2, only a single workflow processing device 210 in the overall workflow system, or there may be multiple workflow processing devices 210.

Next, the configurations of the activity processing device 201 and the workflow processing device 210 shall be described in detail using FIG. 3. The details of the configuration of the activity processing device 221 are identical to those of the activity processing device 201, and thus descriptions thereof shall be omitted. FIG. 3 is a diagram illustrating detailed configurations of the activity processing device and the workflow processing device. The application program 202 installed in the activity processing device 201 further includes a script program execution module 301 and an application function module (called a “function module” hereinafter) 302.

Here, the function module 302 is the portion that executes the principle function of that application program. If, for example, the application program 202 is a document processing application program, the function module 302 executes the document processing function, whereas if the application program 202 is an image processing application, the function module 302 executes the image processing function. If the application program is interactive, the function module 302 executes a function for interactive processing with a user, through a normal user interface.

The script program execution module 301 is the portion that composes the application program 202, and, when the function module 302 is to be controlled by a script program provided from the exterior, executes and manages that script program.

At present, many interactive applications have functions whereby the function module 302, which is the unique function of that application, is controlled by the script program, which is an external program, for the purpose of automating typical tasks. When the providers of multiple application programs are different, it is often the case that the computer language features, such as grammar, libraries, and so on with which the script program is actually written also differ. However, such multiple application programs have a common function where the application program 202 can be controlled as appropriate if an appropriate script program is created. Accordingly, within the application program 202, the script program execution module 301 and the function module 302 are in a relationship in which the script program execution module 301 controls the function module 302 through the execution of a script program.

The workflow control performing portion 203 is another primary piece of software of which the activity processing device 201 is configured. The workflow control performing portion 203 includes an application program execution module 303, an application program interface publication module (called a “publication module” hereinafter) 304, and a workflow message processing module 314. The application program execution module 303 causes the publication module 304 to publicize the function provided by the function module 302 in a format that can be interpreted by the workflow processing device 210. The application program execution module 303 also has a function for converting input information 322 needed by the function module 302 for its actual processing, based on the content of a workflow message (called a “message” hereinafter) 320. This message 320 is generated by the workflow processing device 210 based on the function provided by a publicized application.

The workflow message processing module 314 receives the message 320 generated by the workflow processing device 210 and transfers a script program 321 contained therein to the script program execution module 301, enabling the execution of that script program. The function module 302 is then called through the application program execution module 303, the function requested in the message 320 is executed through the script program 321, and the result of the execution is obtained.

The publication module 304 publicizes various processes executable by the function module 302, which is the function provided by the application program 202, as interface information. This publication is for enabling the function provided by the application program 202 to be handled as an activity according to the workflow system as a whole. Here, the publication module 304 composes interface information that allows the application program 202 to obtain the appropriate input/output information for the processes of which the workflow is composed, and makes the interface information public to the exterior. Application program information that enables the application program 202 to be identified, input specification information, and output specification information are written in the interface information in association with one another. The input specification information is information indicating the specifications of parameters for determining the specifications of the data to be processed and the details of that processing, whereas the output specification information is information indicating the specification of the result of that processing.

Through this, it is possible for an external entity to request, via a network, the activity processing device 201 to execute the application program 202. At this time, the format of the information needed by the function module 302 that actually executes the processing may be different from the format of the interface information publicized by the publication module 304.

Next, a case where an arbitrary function module 302 has a function for processing a file in a file system shall be considered. In this case, the function module 302 requires a filename for identifying the file that is to be processed as input information. However, the interface information publicized by the publication module 304 may only contain the content itself of the file to processed. In other words, the message 320 does not contain filename information in the input information 322; only information related to the content of the file in question may be contained. In such a case, a temporary file is generated from the content of the input information of the message 320 sent to the application program execution module 303, and the filename thereof is passed to the function module 302 as input information. Here, the message 320 is an XML message based on the SOAP specification, and extension information using a unique namespace for identifying the information is written within the message 320.

Meanwhile, the workflow control request portion 212 in the workflow processing device 210 includes a script program advance processing module 312 and a workflow message generation module 313. The workflow process execution portion 213, meanwhile, includes a workflow program description 310 and a workflow program engine 311.

The workflow program description 310 is a description for a workflow program that expresses, as a workflow, a series of processes composed by combining the content of processes publicized by multiple activity processing devices. Processing content compliant with conventional workflow management system techniques, such as BPEL4WS, can be specified in activities that can be represented by the workflow program description 310. In other words, in addition to calling the functions of each activity processing device, other activities, such as processing switches based on conditional judgments, temporary suspension of processing, stopping and resuming processing, and so on can also be described. Multiple workflow program descriptions 310 may be present in a single workflow processing device 210. A single workflow program description 310 sometimes represents a single task, and a single task is sometimes composed of multiple workflow program descriptions 310. The workflow programs described in the workflow program description 310 are executed by the workflow program engine 311.

Here, the script program advance processing module 312 analyzes the workflow program described by the workflow program description 310. The script program advance processing module 312 then determines, in advance and prior to its execution, the script program corresponding to the function module 302 that is to be executed by the workflow program, and stores that script program within the workflow program in advance.

The workflow program engine 311 issues a message creation request to the workflow message generation module 313. The generated message 320 requests processing to be performed by the application program execution module 303 in the activity processing device that will perform the actual processing. The workflow message generation module 313 obtains the script program 321 stored in the script program advance processing module 312 as necessary. The script program 321 is then stored in the message 320 along with the input information 322 and output information 323 obtained from the workflow program description 310 being executed by the workflow program engine 311. After this, the workflow message generation module 313 returns the generated message 320 to the workflow program engine 311.

The message 320 is a message with which the workflow processing device 210 makes a request to an activity processing device (201, 221) for an activity (service) in a workflow. The message 320 is sent to the workflow message processing module 314 by the workflow process execution portion 213, and is received by the application program execution module 303. The message 320 contains information necessary for the workflow processing device 210 to use the function of an application provided by the function module 302 of the application program 202. In other words, a script program 321 used by the application program 202 to control the function module 302 through the script program execution module 301 is included in the message 320. Furthermore, the message 320 includes input information 322 composed of parameter information for determining the data to be processed in that process and the processing content thereof, and output information 323 that indicates the result of that processing.

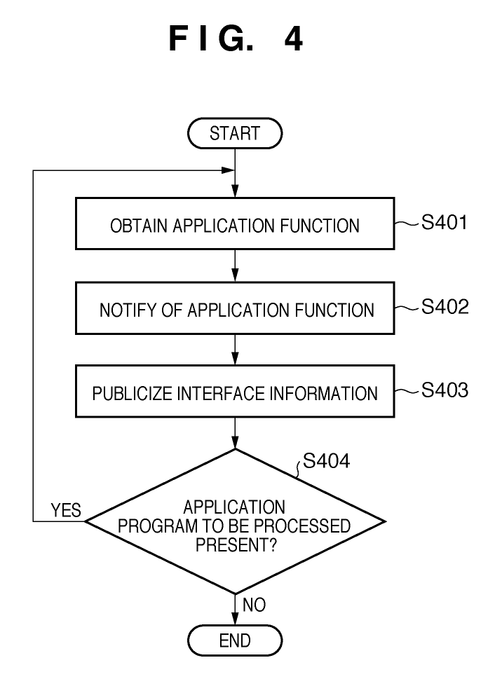

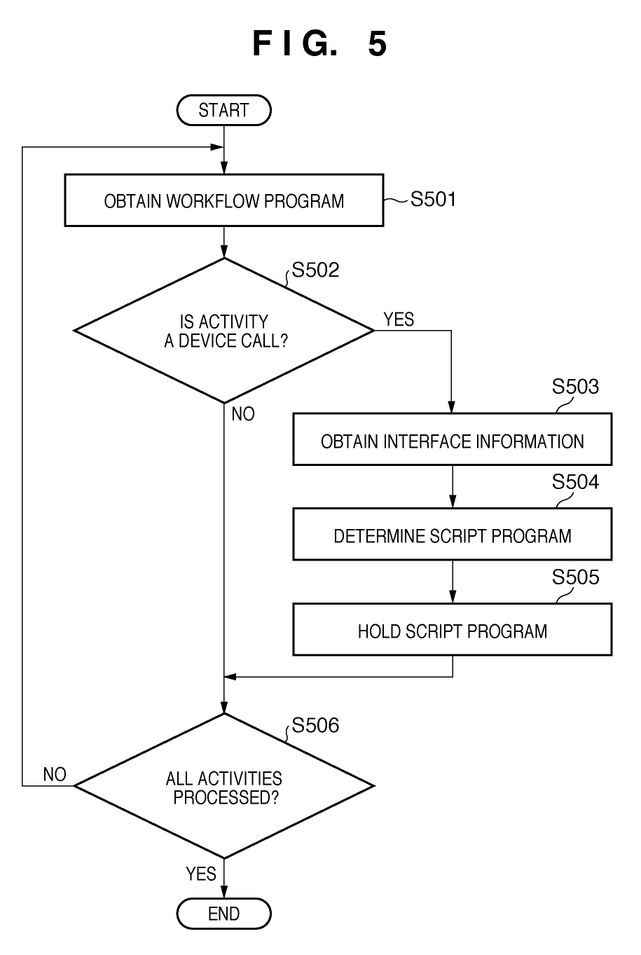

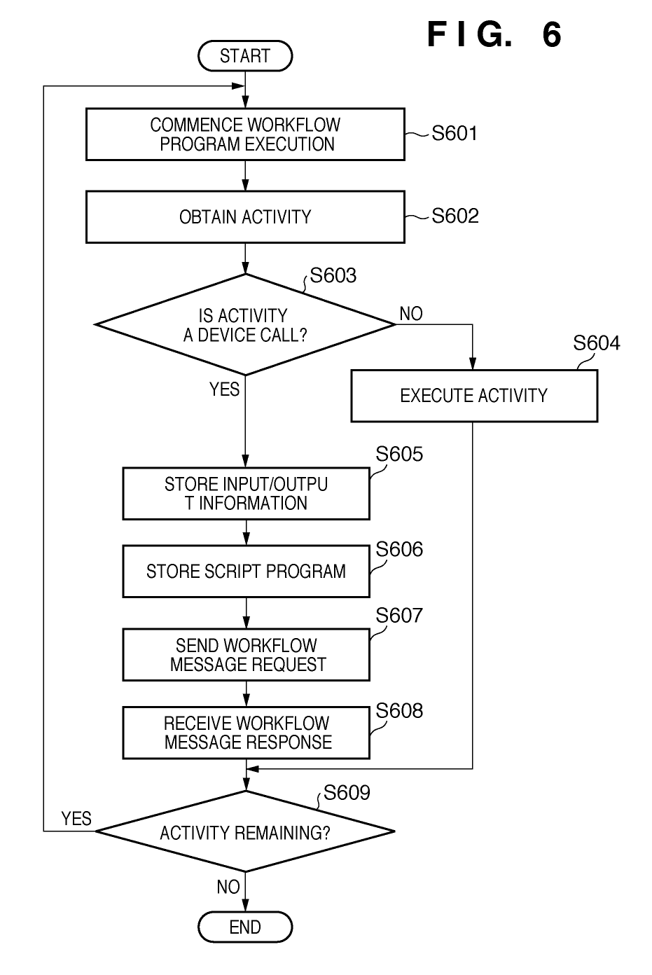

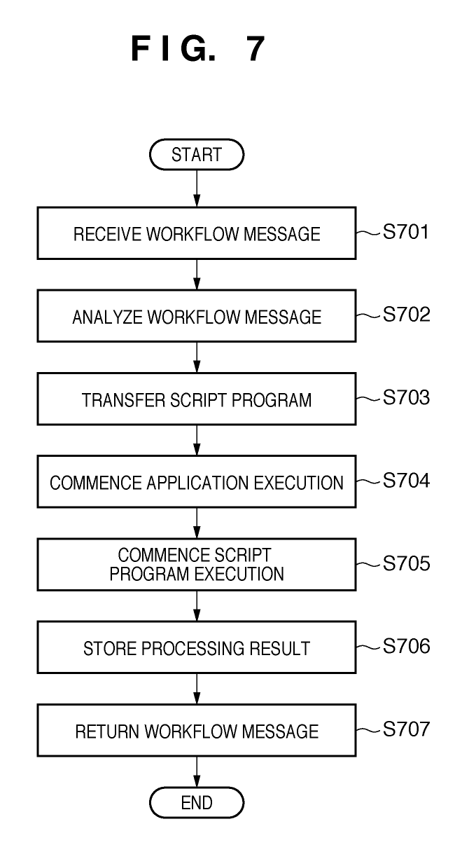

Next, the processes performed by each device in a workflow system configured as described thus far shall be described using FIGS. 4 through 7. FIGS. 4 and 5 illustrate what sort of processes each instance of software in the devices performs, with respect to the processing in the preparation stage, before the workflow processing is actually executed. FIGS. 6 and 7, meanwhile, illustrate what sort of processes each instance of software in the devices performs, with respect to the processing in the stage in which the workflow processing is actually executed.

FIG. 4 is a flowchart illustrating processing executed by an activity processing device as preparation before a workflow program process is executed. It is assumed here that the preexisting application programs to be processed are already installed in the activity processing devices 201 and 221, and that the configuration of the application program 202 is complete. In other words, this processing is performed in the case where the function module 302 is already present in the activity processing devices 201 and 221.

First, in step S401, the application program execution module 303 obtains a function that can be processed by an activity processing device from the function module 302. Then, in step S402, the application program execution module 303 communicates information of the obtained function that can be processed to the publication module 304. Next, in step S403, the publication module 304 generates and publicizes interface information for enabling the specified function to be executed from the exterior. Finally, in step S404, it is determined whether or not there are any remaining application programs 202 to be processed. If the result of the determination indicates that such an application program remains, the procedure returns to step S401, and the aforementioned processing is repeated, whereas if no such application program remains, the procedure ends.

FIG. 5 is a flowchart illustrating processing executed by a workflow processing device as preparation before a workflow program process is executed. The processing described here is performed after the workflow program description 310 has already been installed in the workflow process execution portion 213.

First, in step S501, the script program advance processing module 312 loads and analyzes the workflow program description 310 contained in the workflow process execution portion 213. Next, in step S502, the script program advance processing module 312 sequentially extracts the activities of the workflow program composed by the workflow program description 310. It is then determined whether an extracted activity is an activity description for calling the activity processing device 201 or 221, which are on the exterior.

If the result of the determination indicates that the activity calls the activity processing device 201 or 221, the procedure advances to step S503. In step S503, the script program advance processing module 312 accesses the publication module 304 installed in the device over the network. The script program advance processing module 312 then obtains interface information that can be processed by the function module 302 of the device from the publication module 304. The interface information obtained here includes application program information that enables the identification of the function module 302 that will actually execute the process when that process is requested of the activity processing device 201 or 221. The interface information also includes information for associating the input specification information, which is information indicating the specifications of parameters for determining the specifications of the data to be processed and the details of that processing, with the output specification information, which is information indicating the specification of the result of that processing.

Next, in step S504, the script program advance processing module 312 determines the script program that is needed by the function module 302 when performing the desired process, based on the obtained application program information, input specification information, and output specification information. This processing is carried out by the script program advance processing module 312 in the workflow control request portion 212. Then, in step S505, the script program determined in step S504 is stored as part of the activities of the workflow program that compose the workflow program description 310 handled in step S503. Thereafter, the workflow program engine 311 of the workflow process execution portion 213 can refer to that script program during execution.

When the determination in step S502 results in “no”, or when the processing of step S505 ends, the procedure advances to step S506, where it is determined whether or not all the activities in the workflow program description 310 have been processed. If all the activities have not been processed, the procedure returns to step S502, and the aforementioned processing repeated, whereas if all activities have been processed, the procedure ends.

FIG. 6 is a flowchart illustrating processing executed by a workflow processing device at the stage when a workflow program process is actually executed. First, in step S601, the workflow program described in the workflow program description 310 of the workflow process execution portion 213 is loaded into the workflow program engine 311, and the execution of the workflow process is commenced.

Next, in step S602, the workflow program engine 311 obtains an activity to be executed from the workflow program description 310. Then, in step S603, it is then determined whether the obtained activity is an activity for calling an activity processing device on the exterior. If the result of the determination indicates that the activity to be executed is not a device call activity, the procedure advances to step S604, and that activity is executed. Here, an activity that is not a device call activity is an activity for processing switches based on conditional judgments, temporary suspension of processing, stopping and resuming processing, and so on.

If, however, the result of the determination in step S603 indicates that the activity to be executed is a device call activity, the procedure advances to step S605. In step S605, the workflow program engine 311 requests the workflow message generation module 313 to create a message 320 for calling the function provided by that activity processing device 201. Having received the request, the workflow message generation module 313 first generates an empty message 320. The workflow message generation module 313 then stores the input information 322 and output information 323 based on the specification of the input information and output information obtained from the currently-executed workflow program description 310 in the previous step S503, which is a preparation stage, in the message 320.

Next, in step S606, the script program 321 determined and held in steps S503 to S505 is stored in the message 320. Through this, the information necessary for the workflow processing device 210 to use the function of the application provided by the function module 302 is stored in the message 320. The script program 321 is used by the script program execution module 301 to control the function module 302. The input information 322 is parameter information for determining the data to be processed in that process and the processing content thereof, and the output information 323 is information that indicates the result of that processing.

Next, in step S607, the workflow program engine 311 sends the generated message 320 to the application program execution module 303 of that activity processing device over the network. Then, in step S608, the workflow program engine 311 receives the result of the processing from the application program execution module 303. Note that the processing executed central to the application program execution module 303 of the activity processing device described in steps S607 and S608 shall be described in further detail using FIG. 7. Next, in step S609, the workflow program engine 311 determines whether or not all activities have been executed, and if not, the procedure returns to step S602, and the aforementioned processing is repeated. The processing ends, however, if the workflow program engine 311 has executed all the activities.

FIG. 7 is a flowchart illustrating processing executed by an activity processing device at the stage when a workflow program process is actually executed. This processing is executed by the application program execution module 303 when the workflow message is received from the workflow processing device 210, as indicated in steps S607 and S608 in FIG. 6.

First, in step S701, the workflow message processing module 314 of the activity processing device receives the message 320 from the workflow program engine 311 of the workflow processing device 210. Next, in step S702, the received message 320 is separated into the aforementioned script program 321, input information 322, and output information 323. Then, in step S703, the application program execution module 303 acquires the script program 321 from the workflow message processing module 314 and transfers the script program 321 to the script program execution module 301. At this time, the input information 322 separated in step S703 is passed to the script program execution module 301 as input parameters.

Then, in step S704, the application program execution module 303 commences the execution of the application program 202 upon being instructed by the workflow message processing module 314 to execute the application program 202. Next, in step S705, the script program execution module 301 commences the execution of the script program 321 passed thereto. The script program execution module 301 executes the script program 321 using the input information 322. When the execution of the specified script program 321 ends, in step S706, the result of the execution is stored in the output information 323. Then, in step S707, the updated output information 323 is transferred to the application program execution module 303 as the result of processing the message 320. The application program execution module 303 then returns that processing result to the workflow program engine 311 via the workflow message processing module 314.

According to the first embodiment, a preexisting application program can be utilized as an activity, which is a part of a workflow system, over a network, without altering a device that has already been installed and is running. Furthermore, the application program can become network-compliant without being modified, even if the application program lacks a function for acquiring various processing requests over the network and returning the results of that processing.

Next, a second embodiment according to the present invention shall be described in detail with reference to the drawings. The configurations of the computer devices that function as workflow processing devices and activity processing devices in the second embodiment are the same as in the first embodiment described using FIG. 1, and thus descriptions thereof shall be omitted. Furthermore, the general software configurations of the workflow processing device and activity processing devices in the workflow system are the same as those described in the first embodiment using FIG. 2, and thus descriptions thereof shall be omitted.

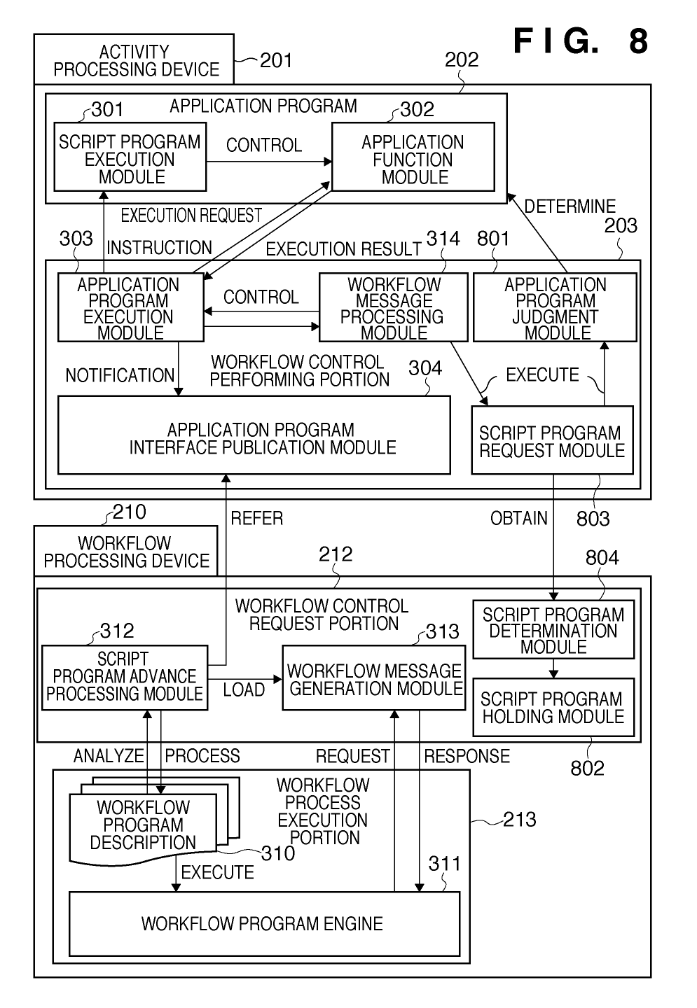

FIG. 8 is a diagram illustrating detailed configurations of an activity processing device and a workflow processing device according to the second embodiment. Note that elements having the same functions as those in the first embodiment described using FIG. 3 shall be given the same reference numerals here, and descriptions thereof shall be omitted. As shown in FIG. 8, in the second embodiment, the workflow control performing portions 203 of the activity processing devices 201 and 221 each include an application program judgment module 801 and a script program request module 803. Meanwhile, the workflow control request portion 212 in the workflow processing device 210 includes a script program determination module 804 and a script program holding module 802. The workflow message 320 has been omitted from FIG. 8.

First, the application program judgment module 801 is a module that recognizes multiple application programs 202 when they are executed and individually judges script programs 321 that can be executed by each application program. The script program holding module 802 holds multiple differing script programs 321 corresponding to multiple application programs 202. Through this, multiple script programs 321 each represent the content of processes publicized by multiple publication modules 304.

The script program request module 803 sends, to the script program holding module 802, information regarding the application programs judged by the application program judgment module 801. The script program request module 803 also sends, to the script program holding module 802, information regarding the processing content specified by the publication module 304. The script program determination module 804 receives the information from the script program request module 803 and determines the appropriate script program 321 from the script program holding module 802.

Accordingly, the script program 321 determined statically in step S504 in the first embodiment can, in the second embodiment, also be stored during the execution of the workflow program. In other words, the function module 302, which is the primary executor of the actual activity processing, is dynamically judged by the application program judgment module 801 during the execution of the workflow process. Through this, a script program 321 executable by the application program 202 can be determined during execution, and that script program 321 can then be dynamically stored within the message 320.

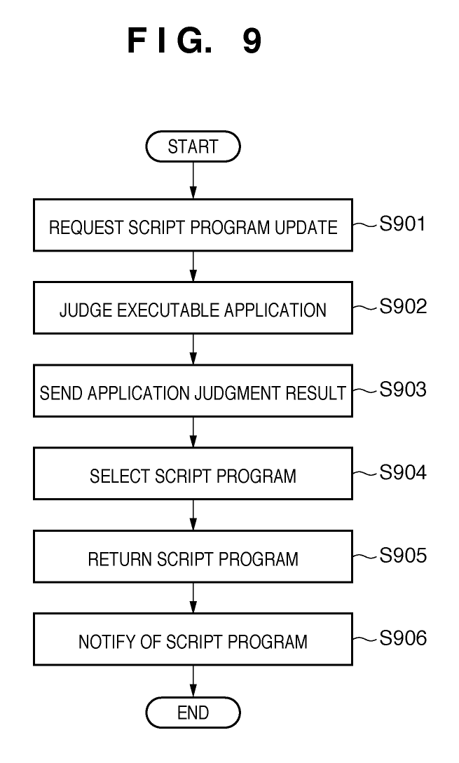

FIG. 9 is a flowchart illustrating the characteristic part of the processing performed in the second embodiment. The processing replaces the processing of step S606 in FIG. 6 and described in the first embodiment; the overall processing, however, is the same as shown in FIG. 6. In other words, the entirety of the processing shown in FIG. 9 replaces step S606 in FIG. 6. In the present embodiment, the script program 321 is not stored in the message 320.

First, in step S901, the workflow message processing module 314 receives the message 320 and issues a script program update request to the script program request module 803. Then, in step S902, the application program judgment module 801 judges the executable function modules 302 based on the request from the script program request module 803. Next, in step S903, the script program request module 803 sends the result of the judgment made in step S902 to the script program determination module 804 over the network.

Then, in step S904, the script program determination module 804 searches the script programs held by the script program holding module 802 based on the content of the request. The appropriate script program is then selected as the script program 321. After this, in step S905, the script program determination module 804 returns the selected script program 321. Finally, in step S906, the script program request module 803 notifies the workflow message processing module 314 of the selected script program 321.

Meanwhile, having been notified, the workflow message processing module 314 continues processing in the same manner as if the script program 321 was contained in the workflow message 320.

Note that the present invention may be applied to a system configured of a plurality of devices (e.g., a host computer, an interface device, a reader, a printer, and so on) or to an apparatus configured of a single device (e.g., a copy machine, a facsimile device, and so on).

Furthermore, the object of the present invention can also be achieved by supplying, to a system or apparatus, a storage medium in which the program code for software that realizes the functions of the aforementioned embodiments has been recorded, and causing a computer (CPU or MPU) of the system or apparatus to read out and execute the program code stored in the storage medium. According to such an aspect, the program code itself read out from the computer-readable storage medium implements the functionality of the aforementioned embodiment, and the storage medium in which the program code is stored composes the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-191378, filed Jul. 24, 2008, which are hereby incorporated by reference herein in their entirety.

What is claimed is:

1. A workflow processing apparatus connected to a network, the apparatus comprising:
a receiving unit that receives interface information of a function provided by a device on the network from the device on the network; and
a sending unit that, during the processing of a workflow, sends input information based on the interface information of the function provided by the device on the network and a program for controlling the function provided by the device on the network to the device on the network.

2. The apparatus according to claim 1, wherein in a case where a function included in the workflow is provided by the device on the network, the sending unit sends, to the device on the network, the input information based on the interface information of the function provided by the device on the network and the program for controlling the function provided by the device on the network.

3. The apparatus according to claim 1, wherein the sending unit sends a message including the input information and the program to the device on the network.

4. The apparatus according to claim 1, wherein the sending unit sends the program in response to a request from the device on the network.

5. A storage medium storing a computer program for a workflow processing apparatus connected to a network, the computer program causing a computer to execute:
receiving interface information of a function provided by a device on the network from the device on the network; and
sending, during the processing of a workflow, input information based on the interface information of the function provided by the device on the network and a program for controlling the function provided by the device on the network to the device on the network.

6. The medium according to claim 5, wherein in a case where a function included in the workflow is provided by the device on the network, the input information based on the interface information of the function provided by the device on the network and the program for controlling the function provided by the device on the network are sent to the device on the network.

7. The medium according to claim 5, wherein a message including the input information and the program is sent to the device on the network.

8. The medium according to claim 5, wherein the program is sent in response to a request from the device on the network.

9. A method used by a first device connected to a network when the first device uses a function provided by a second device during the processing of a workflow, the method comprising:
receiving interface information of a function provided by the second device on the network from the second device; and
sending, during the processing of a workflow, input information based on the interface information of the function provided by the second device and a program for controlling the function provided by the second device from the first device to the second device.

10. The method according to claim 9, wherein in a case where a function included in the workflow is provided by the second device, the input information based on the interface information of the function provided by the second device and the program for controlling the function provided by the second are sent from the first device to the second device.

11. The method according to claim 9, wherein a message including the input information and the program is sent from the first device to the second device.

12. The method according to claim 9, wherein the program is sent from the first device to the second device in response to a request from the second device.
